(19) United States
(12) Patent Application Publication
(10) Pub. No.: US 2007/0029711 A1
(43) Pub. Date: Feb. 8, 2007

(54) Suspension apparatus for vehicle

(75) Inventors: Shigeki Ehara, Saitama (JP); Tsukasa Fukuzato, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/498,804

(22) Filed: Aug. 4, 2006

(30) Foreign Application Priority Data
Aug. 5, 2005 (JP) P. 2005-227765

(51) Int. Cl. F16F 9/43

(52) U.S. Cl. 267/64.28

(57) ABSTRACT

In the present invention, when the controlling of the damping force of a damper by an actuator becomes impossible in a suspension apparatus for a vehicle, having an actuator for controlling the damping force of the damper for a suspension from which a wheel is suspended from a vehicle body, and a regulating device that regulates a vehicle height by extending and contracting the damper, the vehicle height regulation device extends and contracts the damper and thereby reduce the vehicle height. Therefore, even when the damper is fixed in a low damping force condition with the rolling rigidity and pitching rigidity of the vehicle in a lowered state, the stability of the vehicle can be secured by extending and contracting the damper by the actuator and thereby reducing the vehicle height and lowering the center of gravity of the vehicle.

### BACKGROUND OF THE INVENTION

1. Technical Field

The present invention relates to a suspension apparatus for vehicles provided with a damping force controller adapted to control the damping force of a damper in a suspension that suspends a wheel from a vehicle body.

2. Related Art

A suspension apparatus is known from JP-A-9-39535, in which when an electromagnetic valve for changing a spring constant of an air spring malfunctions while a vehicle provided with a variable damping force damper is subjected to a rolling control operation, the posture variation of the vehicle body due to a decrease in the spring constant of the air spring is rendered moderate by setting the damping force of the damper maximally and thereby securing the operation stabilization performance.

However, when a variable damping force damper in the related art suspension apparatus described above malfunctions when the apparatus is fixed in a low damping force condition, a balance between the damping force and spring constant is lost. Then it becomes difficult to set properly the rolling of the vehicle body.

The present invention has been made in view of the above-described facts, and aims at stabilizing the behavior of a vehicle when variable damping force damper malfunctions cannot control the damping force.

### SUMMARY OF THE INVENTION

To achieve these objects, according to an aspect of the invention, there is provided a suspension apparatus for a vehicles comprising: a damper in a suspension that suspends a wheel from a vehicle body, a controller that controls a damping force of the damper, and a regulating device that regulates a vehicle height by extending and contracting the damper, wherein when control of the damping force of the damper by the damping force controller becomes impossible, the vehicle height regulation device contracts the damper to reduce the vehicle height.

According to another aspect of the invention, there is provided a suspension apparatus for vehicles comprising: a damper in a suspension that suspends a wheel from a vehicle body, a controller that controls a damping force of the damper, and a regulating device that regulates a spring constant of a suspension spring damper, wherein when control of the damping force of the damper by the damping force controller becomes impossible, the spring constant regulating device reduces the spring constant of the suspension spring.

An actuator 5 in the embodiment corresponds to the damping force controller of the present invention.

Even when the damping force controller of the damper in the suspension malfunctions and the damper is fixed in a low damping force condition with the rolling rigidity and pitching rigidity of the vehicle body in a lowered state, the stability of the vehicle can be secured by contracting the damper by the vehicle height regulation device to cause the height of the vehicle to be reduced and the center of gravity of the vehicle body to be lowered.

Even when the damping force controller of the damper in the suspension malfunctions and the damper is fixed in a low damping force condition with the rolling rigidity and pitching rigidity of the vehicle body in a lowered state, the spring constant of the suspension spring can be reduced by the spring constant regulation device, and the stability of the vehicle can be secured with the balance between the damping force and spring constant suitably maintained.

### BRIEF DESCRIPTION OF THE DRAWINGS

FIG. 1 is a front view of a suspension apparatus for vehicles;

FIG. 2 is an enlarged view of a portion 2 of FIG. 1;

FIG. 3 is a block diagram of a control system for an actuator for changing the damping force of the damper;

FIG. 4 is a diagram showing a model of a suspension;

FIG. 5 is an illustration of the controlling of a sky hook;

FIG. 6 is a flow chart showing the effect of the rolling posture control operation;

FIG. 7 is a map from which a target current for the actuator is retrieved;

FIG. 8 is a graph showing lateral acceleration and lateral acceleration differentiation value recorded when a lane change is conducted;

FIG. 9 is a diagram showing the behavior of a vehicle observed when a lane change is conducted; and

FIG. 10 is a graph showing a vibration transmission rate recorded during the sky hook control operation.

### DETAILED DESCRIPTION OF THE PREFERRED EMBODIMENTS

An embodiment of the present invention will now be described on the basis of an embodiment shown in the attached drawings.

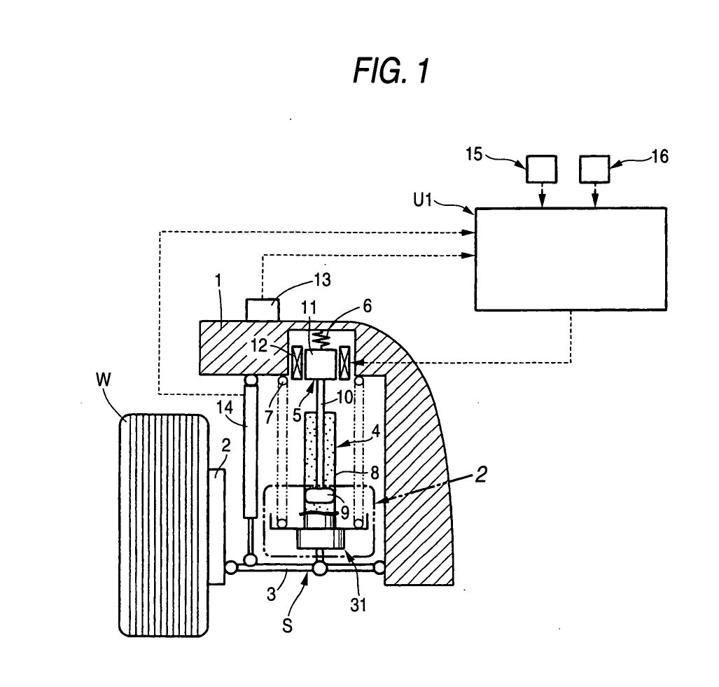

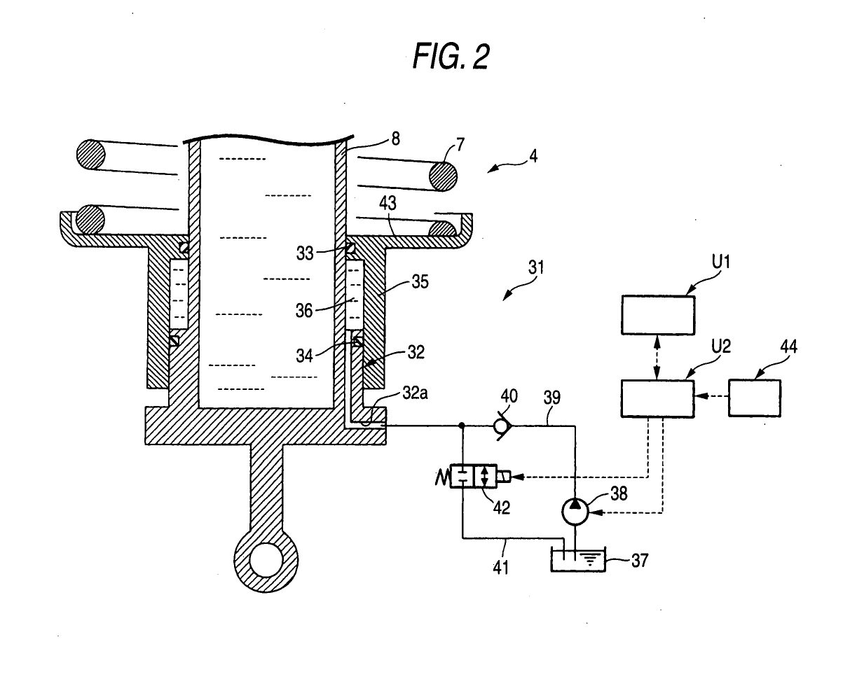

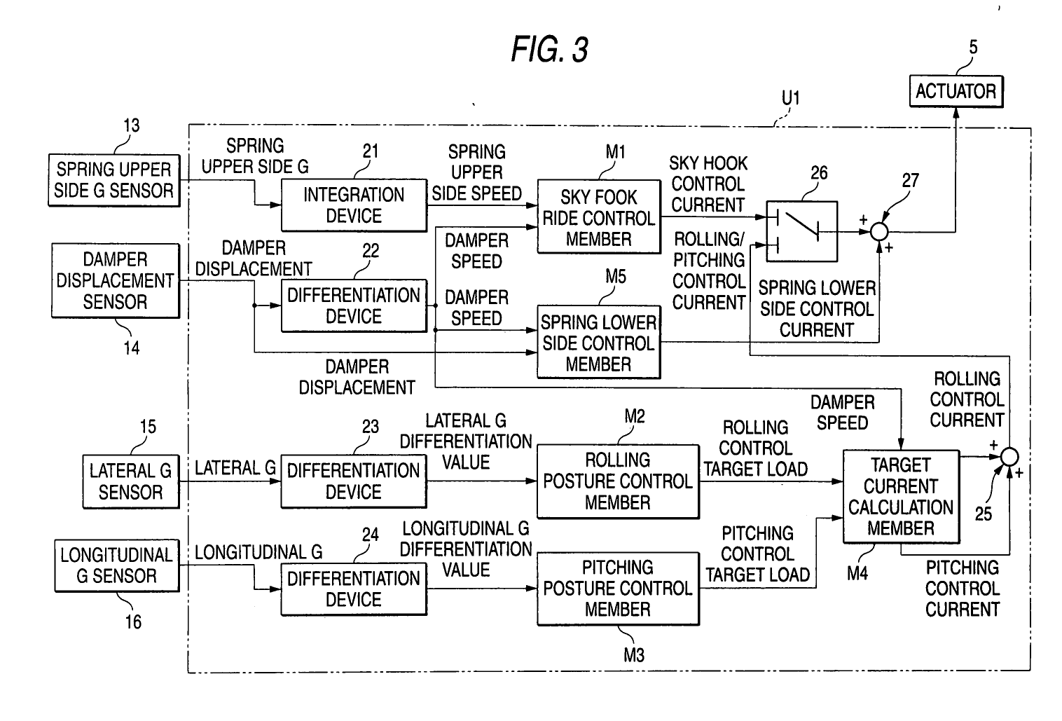

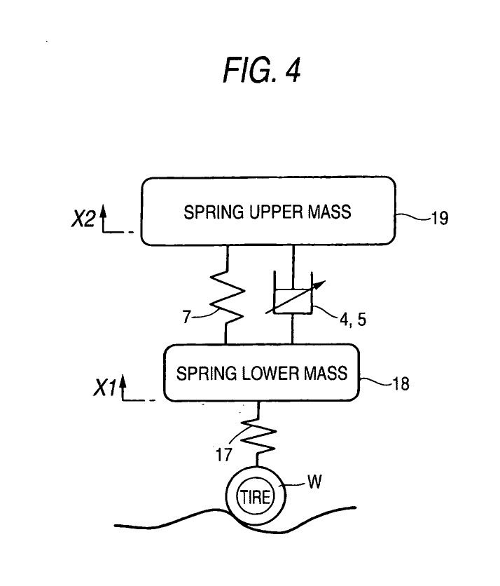

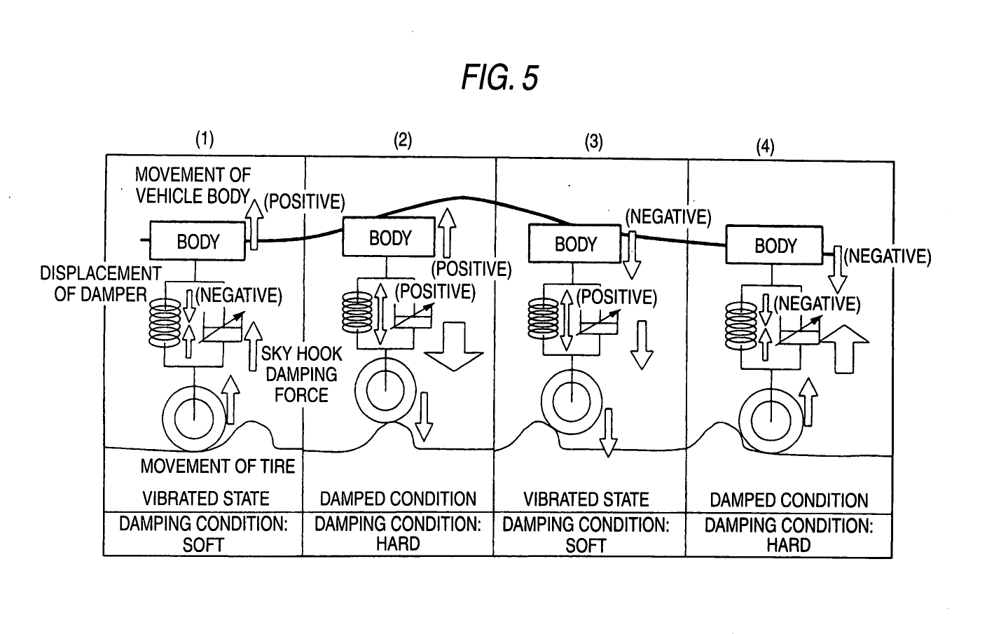

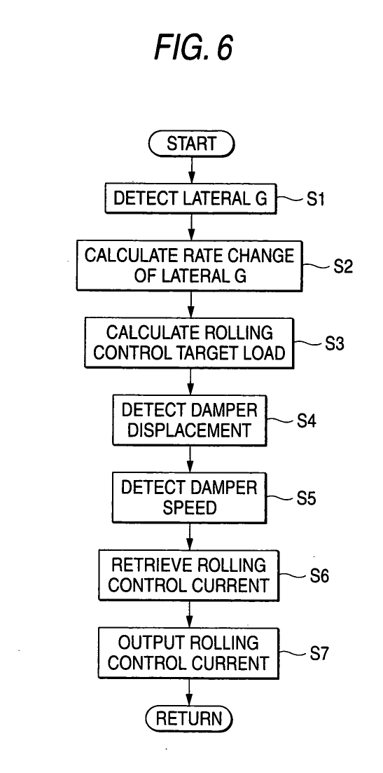

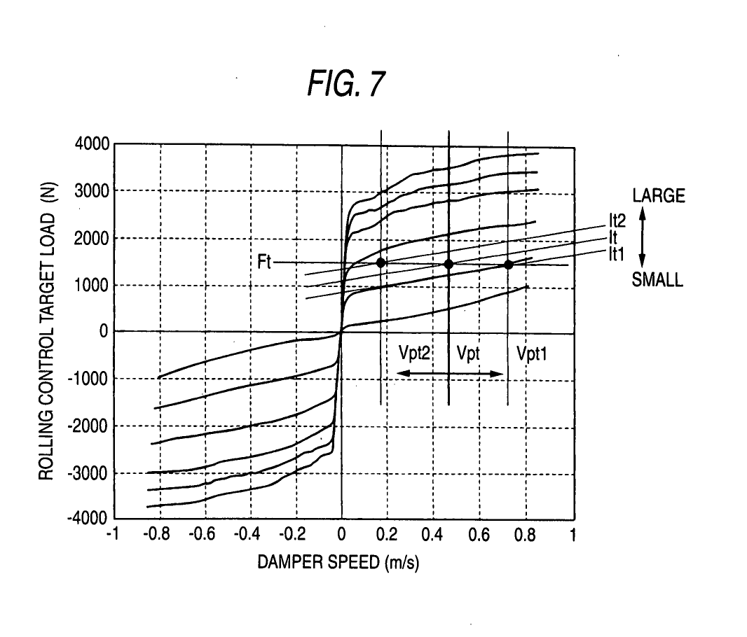

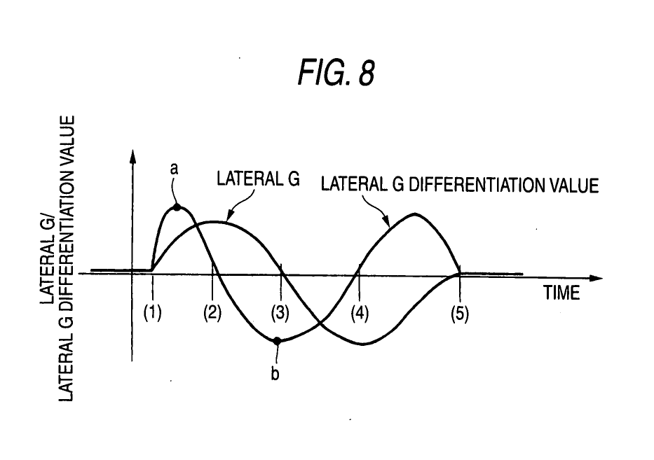

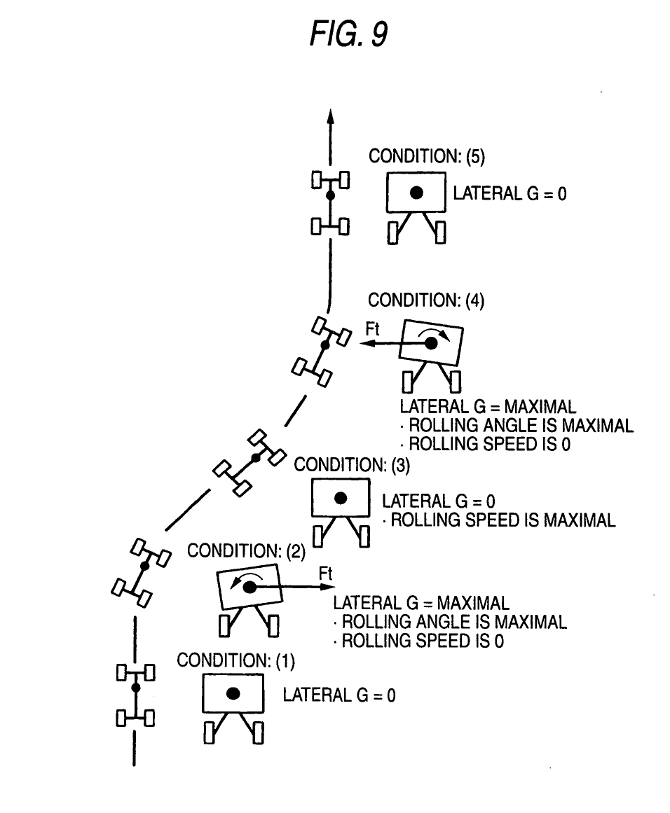

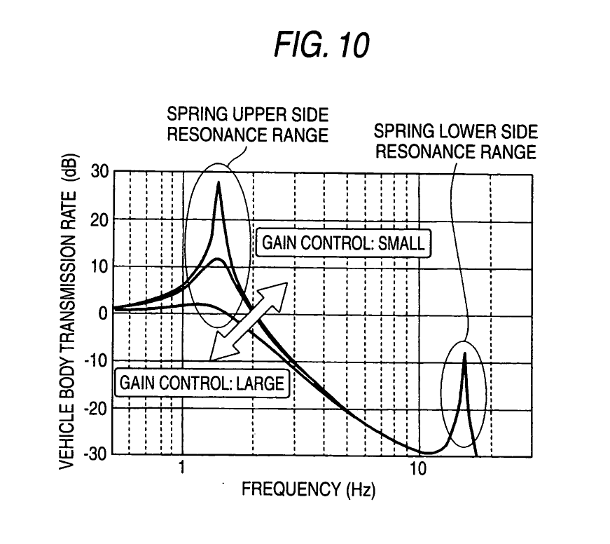

FIG. 1 to FIG. 10 show an embodiment of the present invention, wherein FIG. 1 is a front view of a suspension apparatus for a vehicle, FIG. 2 is an enlarged sectional view of a portion 2 of FIG. 1, FIG. 3 is a block diagram of a control system for an actuator for changing a damping force of a damper, FIG. 4 is a diagram showing a model of a suspension, FIG. 5 is an illustration of a sky hook control operation, FIG. 6 is a flow chart showing an effect of a rolling posture control operation, FIG. 7 is a diagram showing a map for retrieving a target current of the actuator, FIG. 8 is a graph showing lateral acceleration and a lateral acceleration differentiation value to be retrieved when a lane change is conducted, FIG. 9 is a diagram showing vehicle behavior observed when a lane change is conducted, and FIG. 10 is a graph showing a vibration transmission rate in a sky hook control operation.

As shown in FIG. 1, a suspension S for suspending a wheel W 1 of a four-wheel vehicle includes a suspension arm 3 for supporting a knuckle 2 so that the knuckle 2 can be vertically moved, a damper 4, an actuator 5 and damper mount rubber 6 arranged in series to connect the suspension 3 and a vehicle body 1 together, and a coiled spring 7 for connecting the suspension arm 3 and vehicle body 1 together. The damper 4 includes a cylinder 8 supporting a lower end thereof on the suspension arm 3, a piston 9 slidably fitted in the cylinder 8, and a piston rod 10 extending upward from the piston 9. The actuator 5 includes a core 11 connecting the upper end of the piston rod 10, the lower end of the damper mount rubber 6, and the coil 12 that surrounds the outer periphery of core 11 together. The damper 4 is of a known hydraulic type, and generates a load (damping force) in accordance with a moving speed of the piston 9 when the piston 9 is moved in the interior of the cylinder filled with oil.

Into a first electronic control unit U1 for controlling an operation of the actuator 5 are inputted, a signal from a spring acceleration sensor 13, a signal from a damper displacement (stroke) detecting sensor 14, a signal from a vehicle lateral acceleration detecting sensor 15, and a signal from the vehicle longitudinal acceleration detecting sensor 16. On the basis of these signals, the first electronic control unit U1 controls a current supplied to the damper 4, and can thereby change the damping force arbitrarily.

As shown in FIG. 2, a vehicle height regulating device 31 that increases and decreases the length of the damper 4 and regulates the vehicle height includes a vehicle height regulating piston 32 provided on an outer circumference of a lower end of the cylinder 8 of the damper 4 in one body, a vehicle height regulation cylinder 35 fitted slidably around the outer circumferences of the piston 32 and cylinder 8 via seal members 33, 34, an oil chamber 36 defined by these vehicle height regulation cylinder 35 and cylinder 8, and oil port 32a communicating with the oil chamber 36 formed in the interior of the vehicle height piston 32, an oil pump 38 for drawing up a work oil from an oil tank 37, a check valve 40 provided in an oil passage 39 that connects the oil tank 37 and oil port 32a together, and a switch valve 42 provided in an oil passage 41 that connects the oil tank 37 and oil port 32a together. A lower end of the coiled spring 7 is supported on a spring seat 43 provided on an upper end of the vehicle height regulation cylinder 35 so as to be integral therewith. A vehicle height regulating switch 44 for shifting the vehicle height in a plurality of stages, oil pump 38, and switch valve 42 are connected to a second electronic control unit U2 that is connected to the first electronic unit U1.

Therefore, when the vehicle height shifting switch 44 is operated on the side of the vehicle height increasing side, the oil pump 38 is operated. The work oil in the oil tank 37 is then supplied to the oil chamber 36 through the check valve 40 and causes the vehicle height regulating cylinder 35 to be pressed up with respect to the vehicle height regulation piston 32, thereby compressing the coiled spring 7. As a result, the piston 9 is driven in the direction in which the piston 9 is pushed out from the cylinder 8 by a resilient force of the coiled spring 7, and the damper 4 is extended to cause the vehicle height to increase. In the meantime, when the oil pump 38 is stopped and the switch valve 42 is opened, the vehicle height regulation cylinder 35 lowers while pushing back the work oil in the oil chamber 36 owing to the vehicle weight, so that the damper 4 contracts and the vehicle height decreases.

As shown in FIG. 3, the first electronic control unit U1 includes a sky hook riding comfort control member M1, a roll posture control member M2, a pitch posture control member M3, a target current calculation member M4, and a spring lower side control member M5. The spring acceleration outputted from the spring acceleration sensor 13 is integrated by an integration device 21 into a spring upper and lower sides speeds, which are inputted into the sky hook riding comfort control member M1. The damper displacement outputted from a damper displacement sensor 14 is inputted directly into the sky hook riding comfort control member M1, and differentiated by a differentiation device 22 to turn the damper displacement into a damper speed, which is inputted into the sky hook riding comfort control member M1 and spring lower side control member M5. The lateral acceleration outputted from the lateral acceleration sensor 15 is differentiated by the differentiation means 23 to be turned into a lateral acceleration differentiation value, which is inputted into the roll posture control member M2. The longitudinal acceleration outputted from the longitudinal acceleration sensor 16 is differentiated by the differentiation device 24 to be turned into a longitudinal acceleration differentiation value, which is inputted into the pitch posture control member M3.

The target current calculation member M4 into which a damper speed calculated by the differentiation device 22, a rolling control target load (a target damping force to be generated in the damper 4 to carry out the controlling of the roll) outputted from the roll posture control member M2, and a pitching control target load (a target damping force to be generated in the damper 4 to carry out the controlling of the pitching) are inputted, outputs a roll control current and a pitching control current which are supplied to the actuator 5 of the damper 4. These rolling control current and pitching control current are added to each other in an adding device 25 to be turned into a rolling/pitching control current, which is inputted into a high select device 26. The high select device 26 into which a sky hook control current (a target current for carrying out the sky hook control operation) from the sky hook riding comfort control member M1 in addition to a rolling/pitching control current are inputted, outputs either of the larger one out of the rolling/pitching control current and sky hook control current. A high select value outputted from the high select device 26 and a spring lower side control current (target current for carrying out a spring lower side controlling operation) outputted from the spring lower side control member M5 are added to each other in the adder device 27, and, on the basis of this added value, the operation of the actuator 5 of the damper 4 is controlled.

The function of the sky hook riding comfort control member M1 will now be described on the basis of FIG. 4 and FIG. 5.

As is clear from a model of a suspension shown in FIG. 4, spring lower mass 18 is connected to a road surface via an imaginary spring 17 of a tire, and spring upper mass 19 to the spring lower mass 18 via the damper 4, actuator 5 and a coiled spring 7. The damping force of the damper 4 is variable owing to the actuator 5. The rate of change d X2/dt of the displacement X2 of the spring upper side mass 19 corresponds to the spring upper side vertical speed outputted from the integration device 21 of FIG. 3. The rate of change d (X2−X1)/dt of a difference between the displacement 19 of the spring upper side mass 19 X2 and that of the spring lower side mass 18 X1 corresponds to the damper speed outputted from the differentiation device 22 of FIG. 3.

When dX2/dt×d(X2−X1)/dt>0, i.e., when the spring upper side vertical speed and damper speed are in the same direction (same symbol), the actuator 5 of the damper 4 is controlled in the direction in which the damping force is increased.

In the meantime, when dX2/dt×d(X2−X1)/dt<=0, i.e., when the spring upper side vertical speed and damper speed are in the opposite directions (opposite symbols), the actuator 5 of the damper 4 is controlled in the direction in which the damping force is reduced.

A case where the wheel W goes over a projection on the road surface as shown in FIG. 5 will be considered. While the wheel W moves up along a first half of the first half of the projection as shown in (1), the vehicle body 1 moves up, and the spring upper side vertical speed (dX2/dt) comes to have a positive value. Therefore, the damper 4 is compressed, and the damper speed d(X2−X1)dt comes to have a negative value. Accordingly, both come to have opposite symbols, and the actuator 5 of the damper 4 is controlled so that the damping force in the compression direction is reduced.

Immediately after the wheel gets over the apex of the projection as shown in (2), the vehicle body 1 still moves up due to the inertia, and the spring upper side vertical speed (dX2/dt) comes to have a positive value. Owing to the upward movement of the vehicle body 1, the damper 4 is extended, and the damper speed d (X2−X1)/dt comes to have a positive value. Therefore, both come to have the same symbol, and the actuator 5 of the damper 4 is controlled so that the damping force in the damper extending direction is increased.

While the wheel W moves down along the latter half of the projection as shown in (3), the vehicle body 1 moves down, and the spring upper side vertical seed (dX2/dt) comes to have a negative value. Since the wheel W moves down more quickly than the vehicle body 1, the damper 4 is extended. As a result, the damper speed d (X2−X1)/dt comes to have a positive value, so that both come to have opposite symbols. Therefore, the actuator 5 of the damper 4 is controlled so that the damping force in the extending direction is reduced.

Immediately after the wheel W completely gets over the projection as shown in (4), the vehicle body 1 still moves down due to the inertia, and the spring upper side vertical speed (dX2/dt) comes to have a negative value. When the wheel W stops moving down, the damper 4 is compressed and the damper speed d (X2−X1)/dt comes to have a negative value. Therefore, both come to have the same symbol, and the actuator 5 of the damper 4 is controlled so that the damping force in the compression direction is increased.

When the riding comfort of the vehicle is heightened by carrying out such a sky hook control operation, the damping force of the actuator 5 of the damper 4, i.e. the skyhook control current is calculated in accordance with the expression (proportional constant)×(spring upper side vertical speed) in the regions shown in FIG. 5 (2) and (4) in which the damping force of the actuator 5 of the damper 4 is increased. This reduces a shifting sound and decreases a feeling of physical disorder.

The operation of the roll posture control member M2 and target current calculation member M4 will now be described on the basis of FIG. 6 to FIG. 9.

In Step S1 in the flow chart of FIG. 6, the lateral acceleration is detected by the relative sensor 15, and, in Step S2, the rate of change of the lateral acceleration is calculated by subjecting the lateral acceleration to differentiation by the differentiation device 23. In Step 3, a rolling control target load is calculated in accordance with an expression (proportion constant)×(lateral acceleration differentiation value) in the roll posture control member M2. In the subsequent step S4, the displacement of the damper is detected by the damper displacement sensor 14, and in Step 5, the displacement of the damper is differentiated by the differentiation device 22 to calculate the speed of the damper. In the subsequent step S6, the target current calculation member M4 into which the rolling control target load and damper speed are inputted retrieves the roll control current from the map shown in FIG. 7. In the step S7, the roll control current is outputted to the addition device 25.

FIG. 7 shows the map in which a rolling control current is retrieved from the rolling control target load and damper speed. Although the rolling control current basically has a proportional relation with respect to the rolling control target load on the vertical axis, the rolling control current is corrected by the damper speed. For example, when the rolling control target load is Ft and the damper speed is Vpt, the rolling control current becomes It. When the damper speed increases from Vpt to Vpt1, the rolling control current decreases from It to It1. Conversely, when the damper speed decreases from Vpt to Vpt2, the rolling control current increases from It to It2.

FIG. 8 shows lateral acceleration obtained when the vehicle lane is changed from the left lane to the right lane and a differentiation value obtained by differentiating the same. (1) to (5) on the time axis correspond to the behavior (1) to (5) of the vehicle which is changing lanes as shown in FIG. 9.

In (1), (3), (5) in which the lateral acceleration is zero, the vehicle body 1 is not rolled. In (2) in which the vehicle body 1 is being turned to the right, the vehicle body 1 rolls to left due to the centrifugal force. In (4) in which the vehicle body 1 is being turned to left, the vehicle body 1 rolls to right due to the centrifugal force. By generating the rolling control target load Ft in the damper 4 at this time, the posture of the vehicle can be stabilized while inhibiting the rolling of the vehicle body 1 to the outside of the turning direction.

During this time, the rolling control target load Ft by which the rolling angle of the vehicle body 1 is to be controlled is determined on the basis of the lateral acceleration. Since the lateral acceleration varies in substantially the same phase as the rolling angle, there is the possibility that the controlling of the damping force of the damper 4 be delayed. When attention is paid to the graph of FIG. 8, the absolute value of the lateral acceleration differentiation value becomes maximum at a point a prior to the time at which the leftward lateral acceleration becomes maximum in (2), and the absolute value of the lateral acceleration differentiation value becomes maximum at a point b prior to the time at which the rightward lateral acceleration becomes maximum in (4). In view of the phase in which the lateral acceleration differentiation value varies precedes in the phase in which the lateral acceleration varies, the rolling control target load Ft of the damper 4 that is proportional to this lateral acceleration differentiation value, is set. This enables the damping force of the damper 4 to be controlled without time delay, the posture of the vehicle to be further stabilized, and an accurate posture control operation and a good riding comfort can be accomplished.

Moreover, since the correction by the damper speed is carried out when the target current calculation member M4 map-retrieves the roll control current from the rolling control target load, the deterioration of the riding comfort can be prevented by setting a suitable rolling control target load.

In order to inhibit a nose-up during the quick acceleration of the vehicle and a nose-down during the quick braking thereof, the pitching posture control member M3 calculates pitching control target load on the basis of the longitudinal acceleration differentiation value. This is obtained by differentiating in the differentiation device 24 the longitudinal acceleration detected by the longitudinal acceleration sensor 16, in the same manner as the above-mentioned calculation of the roll control current. The target current calculation member M4 corrects the pitching control current on the basis of the damper speed when the same member M4 map-retrieves the pitching control current from the pitching control target load.

The rolling control current and pitching control current which the target current calculation member M4 outputs are added to each other in the addition device 25. Rolling/pitching control currents representative of the sum are inputted into a high select device 26, in which these currents are compared with the sky hook control current. The larger current is outputted to the addition device 27. In the addition device 27, the resultant current is added to the spring lower side control current which the spring lower side control member M5 outputs, and the damping force of the actuator 5 in the damper 4 is controlled on the basis of this sum.

Any of the larger currents out of the rolling/pitching control current and sky hook control current is selected in this manner by the high select 26 and outputted to the actuator 5. Therefore, while the high select 26 selects the rolling/pitching control currents, the sky hook control and current increases and the moment the sky hook control and current exceeds the rolling/pitching control currents, the rolling/pitching control currents are shifted to the sky hook control current. Conversely, while the high select means 26 selects the sky hook control current, if the rolling/pitching control currents exceed the sky hook control current, the sky hook control current is shifted to the rolling/pitching control currents. In any case, the high select current outputted from the high select device 26 at the current shifting time is not changed quickly in a discontinuous manner, so that the operation of the actuator 5 in the damper 4 avoids giving a feeling of physical disorder to the driver.

Even when the control gain is changed in the above-described sky hook control operation, the vibration transmission rate in the vicinity of 1 Hz, which is a spring upper side resonance frequency, varies only as shown in FIG. 10. The vibration transmission rate in the vicinity of 10 Hz, which is a spring lower side resonance frequency, cannot be controlled.

The spring lower side control member M5 is provided to solve this problem. Attention is given to a product of the damper speed and damper displacement as indices for grasping the vibration in the spring lower side resonance region and controlling the same. The spring lower side control current is calculated in accordance with the expression (proportional constant)×(damper speed)×(damper displacement). The spring lower side control current is added to the high select current outputted from the high select device 26 in the addition device 27. As a result, when the damper speed and damper displacement are large, it becomes possible to inhibit the vibration in the spring lower side region in the vicinity of 10 Hz independently of the sky hook control operation.

When the actuator 5 for the damper 4 and the first electronic control unit U1 malfunction cannot control the damping force, the supplying of an electric current to the actuator 5 is cut off to cause the damping force of the damper 4 to be fixed in the lowest condition, so that the rolling rigidity and pitching rigidity of the vehicle body decrease. When a signal indicating that the controlling of the damping force of the damper 4 is impossible is inputted from the first electronic control unit U1 into the second electronic control unit U2, the second electronic control unit U2 opens the switch valve 42 irrespective of the operation of the vehicle height shift switch 44. The damper 4 is thereby contracted to lower the vehicle height to a minimum level. As a result, the damping force of the damper 4 is fixed in the lowest condition. Even when the rolling rigidity of the vehicle body and the pitching rigidity decrease, the stability of the behavior of the vehicle can be improved by lowering the center of gravity of the vehicle body.

Although the suspension S of the first embodiment described above is provided with a coiled spring 7 as a suspension spring, the suspension S of the second embodiment is an air spring with a variable spring constant. When the controlling of the damping force becomes impossible in this second embodiment because the damping force 5 for the damper 4 and the first electronic control unit U1 malfunction, the spring constant regulation device controls the spring constant of the air spring by lowering it in accordance with a command from the second electronic control unit U2. As a result, a decrease in the damping force of the damper and that of the spring constant the air spring are balanced, so that the property of the suspension S is kept excellent. Therefore, when a lane change and the like is conducted, the inconveniences of the spring constant of becoming excessively large with respect to the damping force do not occur. This can prevent the occurrence of a failure in stopping the rolling of the vehicle body.

The embodiments of the present invention were described above. The designing of the present invention can be modified variously without departing from the gist thereof.

For example, the methods of controlling of the damping force of the damper 4 by the first electronic control unit U is not limited to those described in the embodiments. The controlling of the damping force can be done in an arbitrary manner.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A suspension apparatus for a vehicle, comprising:
a damper in a suspension that suspends a wheel from a vehicle body;
a controller that controls a damping force of the damper; and
a regulating device that regulates a vehicle height by extending and contracting the damper,
wherein when control of the damping force of the damper by the controller becomes impossible, the vehicle height regulation device contracts the damper to reduce the vehicle height.

2. A suspension apparatus for a vehicle, comprising:
a damping force of a damper in a suspension that suspends a wheel from a vehicle body;
a controller that controls a damping force of the damper; and
a regulating device that regulates a spring constant of a suspension spring damper,
wherein when control of the damping force of the damper by controller becomes impossible, the spring constant regulating device reduces the spring constant of the suspension spring.
